(19) United States
(12) Patent Application Publication
(10) Pub. No.: US 2020/0277205 A1
(43) Pub. Date: Sep. 3, 2020

(54) FLUIDIC FLUID PURIFYING DEVICE AND ASSOCIATED PURIFYING METHOD

(71) Applicant: Eden Microfluidics, Paris (FR)

(72) Inventor: Sébastien Cargou, Paris (FR)

(73) Assignee: Eden Microfluidics, Paris (FR)

(21) Appl. No.: 16/647,259

(22) PCT Filed: Sep. 14, 2018
(86) PCT No.: PCT/EP2018/074955

§ 371 Date: Mar. 13, 2020

(30) Foreign Application Priority Data
Sep. 14, 2017 (FR) 1758527

(51) Int. Cl. C02F 1/44; B01D 61/18; B01D 71/12; B01D 71/38; B01D 71/80; B01D 71/04; C02F 1/28; C02F 3/34

(52) U.S. Cl. CPC C02F 1/44; B01D 61/18; B01D 71/12; B01D 71/38; B01D 71/80; B01D 71/04; C02F 2101/203; C02F 1/281; C02F 1/285; C02F 3/342; C02F 2209/03; C02F 2301/046; C02F 2303/16; C02F 1/283

(57) ABSTRACT

The invention relates to a fluidic purifying device designed to clean a fluid of at least one pollutant, comprising a fluidic purification network, characterized in that the fluidic purification network comprises a plurality of microfluidic channels, each microfluidic channel being defined by one or more fluidttight walls, each microfluidic channel comprising at least one zone on the interior surface of said microfluidic channel that exhibits at least one autonomous purifying agent and each microfluidic channel exhibiting, in such a zone, a height less than 60 μm in a direction normal to the main direction of flow of the fluid, the purifying agent or agents, and the sizing of said zones, being configured in such a way as to allow at least 10% of the pollutants to be captured and/or broken down by said zones, for at least one flow rate of the fluid that is to be purified.

### FIELD OF THE INVENTION

The invention relates to a fluidic fluid-purifying device and an associated purifying process, for example used for cleaning wastewater, organic solutions and/or gases.

### PRIOR ART

Wastewater is typically cleaned by treatment plants and then discharged, after treatment, into natural environments such as rivers or maritime coastal areas. The quality of wastewater treated by treatment plants is generally not sufficient to enable treated water to be reintroduced directly for human or animal use, thus preventing the preservation of freshwater reserves.

In a known manner, wastewater treatment can include:
coagulation, flocculation and settling of wastewater, which removes about 60% of the suspended solids in the wastewater. These treatments also reduce the chemical and biochemical oxygen consumption in later stages of wastewater treatment;
granulated filtration, exposure to UVC rays and a treatment using reverse osmosis;
degradation by anaerobic bacteriological processes to treat fats, oils, viruses, bacteria and certain fertilizers.

However, these treatments are not able to purify wastewater of micropollutants. A “micropollutant” is typically defined as a pollutant present in wastewater at a low concentration, typically between 0.1 ng/L and 100 μg/L. Micropollutants can include persistent organic pollutants (POPs), used as pesticides, solvents, pharmaceuticals and industrial chemicals, and environmentally persistent pharmaceutical pollutants (EPPPs). Both types of micropollutant agents are toxic and dangerous to human and animal health, as well as to the balance of the ecosystem. Since 2001, the Stockholm Convention (Stockholm Convention on Persistent Organic Pollutants, 2001) aims to restrict the production and use of POPs.

In a known manner, activated carbon fitters can be used to purify wastewater of micropollutants, particularly organic compounds. Water treated by activated carbon fitters can be reused for industrial applications.

However, activated carbon fitters do not purify the water of sodium, many microbes, fluoride ions, and nitrates. Moreover, only specific types of activated carbons can filter out heavy metals such as lead.

In a known manner, ozonation can inactivate certain viruses, bacteria and/or cysts in wastewater. Ozonation is significantly more effective than chlorine treatment (for example, it is 3000 times more germicidal). Indeed, the rapid conversion of ozone to oxygen in the water makes it possible to limit or eliminate most of the toxic residues during treatment.

However, ozone is biologically extremely reactive and toxic to living organisms, which poses a danger when ozone treated water is subsequently used by humans or animals. In addition, the solubility of ozone varies significantly with temperature: continuous and seasonal adjustments of the concentration of ozone used in wastewater treatment are necessary to ensure optimal treatment without exceeding a toxic dose for users, and thus meet the quality standards imposed by the use of this treatment. In addition, ozonation leads to the formation of bromate in the water, which can be carcinogenic. Ozonation also requires installations using pure liquid oxygen, or compressed, purified and dried air, and electrical power, resulting in high water treatment costs.

It is also known to use filters comprising hollow fiber membranes to purify wastewater of micropollutants. Hollow fibers are generally between 0.6 mm and 2 mm in diameter and can be produced by extrusion of the membrane material. The water is treated by controlling a transmembrane flow.

However, hollow fiber membranes have a high hydraulic resistance. To control a purified water flow rate high enough for an industrial application, it is necessary to control pressures generally between 3 and 15 bar between the inlet and outlet of a membrane. In addition, the morphology of the fibers causes the pores to be blocked by objects to be filtered that are larger than the micropollutants. It is then necessary to backwash the fibers, i.e. to control a flow in the opposite direction of the wastewater treatment flow to clean the hollow fiber membranes. The pressures used for membrane cleaning are typically two to three times higher than the pressures used for water treatment: these pressures, combined with the use of chemical cleaning solutions, affect the mechanical performance of the fibers until they break.

U.S. Pat. No. 5,895,573 describes, to solve this problem, a device comprising successive membranes in which the diameter of the pores formed by the fibers decreases progressively with the direction of flow of the water to be treated.

However, this solution cannot treat wastewater at a pressure lower than 0.5 bar, while at the same time having a long service life due to the mechanical capacities of the fibers described. These pressure conditions make it impossible to directly connect a remediation device to a wastewater outlet and require an adaptation of the pressure at the terminals of the device.

More generally, the use of hollow fiber membranes limits the dimensioning of the water treatment device, limits the choice of materials that can be used to manufacture the treatment device, imposes constraints on the flow of wastewater in the treatment device, requires connections compatible with the use of hollow fiber membranes, in addition, the assembly and packaging of hollow fiber bundles for the manufacture of a purification device can be delicate and costly. Finally, the treatment of hollow fibers with depolluting or purification agents is inefficient, costly and energy-intensive.

In addition, US 20170081219 describes a water remediation system using electroflotation or electrocoagulation in a container with electrodes immersed in a wastewater stream. This method of remediation only treats pollutants that can be degraded by electroflotation or electrocoagulation.

U.S. Pat. No. 7,740,752 describes a remediation device comprising stacked treatment beds configured to receive liquid slicks to be remediated. This method slows the fluid to be treated and thus optimizes the sedimentation of the particles to be filtered in the fluid. This method does not filter pollutants that are too small to be subject to sedimentation.

Finally, Wang et al (Wang, N., Zhang, X., Wang, Y., Yu, W., & Chan, H. L., 2014, Microfluidic reactors for photocatalytic water purification, Lab on a Chip, 14(6), 1074-1082) describe a microfluidic channel whose inner surface has a layer of bismuth vanadate. Electron-hole pairs are produced by bismuth vanadate during tight excitation on it and allow the formation of free radicals in solution. These free radicals cause degradation of methylene blue in solution.

However, the purification flow rate of the microfluidic system described is at most 2 mL/h and is incompatible with industrial applications, for example at flow rates above 1000 L/h. One envisaged application of such a system is a kit for evaluating the performance of a photocatalytic material such as bismuth vanadate.

### SUMMARY OF THE INVENTION

A purpose of the invention is to provide a fluid purifying device for purifying the fluid of micropollutants. Another purpose of the invention is to provide a purifying device for purifying a fluid at a flow rate high enough for an industrial application while applying a usual pressure difference, i.e. less than 5 bar, and preferentially 1 bar, between the inlet and the outlet of the device. Finally, another purpose of the invention is to provide a robust device, which can be reused after regeneration of the specific purification elements and/or high thermal or mechanical stress of the purification elements.

In particular, an object of the invention is a fluidic purification device adapted to purify a fluid of at least one pollutant, comprising a fluidic purification network, characterized in that the fluidic purification network is a three-dimensional array of microfluidic channels, each microfluidic channel being defined by one or more fluid-tight walls, each microfluidic channel having at least one zone on the inner surface of said microfluidic channel having at least one self-contained purification agent and each microfluidic channel having at such a zone a height of less than 60 μm in a direction normal to the main direction of fluid flow, the self-contained purification agent or agents and the dimensioning of said zones being configured to allow capture and/or degradation of at least 10% of the pollutants by said zones, for at least one flow of the fluid to be purified, the device comprising a plurality of distribution channels and a plurality of collection channels, the fluidic purification network connecting the distribution channels and the collection channels and being implemented at least by an array of microfluidic channels connected in parallel.

It is understood that with such a device, it is possible to remove one or more pollutants, particularly micropollutants, from a fluid by confining the fluid to be purified in microchannels. The diffusion of the micropollutants towards the purification agents presented to the walls makes it possible to purify the fluid without increasing the hydraulic resistance of the device and thus to allow the removal of micropollutants at industrial flow rates.

The invention is advantageously complemented by the following features, taken individually or in any of their technically possible combinations:
the three-dimensional array of microfluidic channels (9) comprising a superposition of two-dimensional arrays of microfluidic channels (9), the fluidic purification network (8) connecting the distribution channels (40) and the collection channels (41),
the device comprises at least three stacked layers, at least two sides of one or more layers having, facing at least two layers, a depression pattern configured to form at least two two-dimensional arrays of microfluidic channels when the at least three layers are stacked;
the device comprises at least one distribution channel and at least one collection channel, the fluidic purification network connecting the distribution channel or channels and the collection channel or channels, the hydrodynamic resistance of the distribution channel or channels and the collection channel or channels being strictly tower than the hydrodynamic resistance of the fluidic purification network;
the pattern is configured to form at least in part one or more distribution channels, and at least in part one or more collection channels;
the device comprises at least one primary channel passing through a plurality of adjacent layers to open respectively into at least one distribution channel and/or at least one collection channel formed between two layers;
the stack comprises a superposition of sub-stacks each formed of two layers, said two layers being of different materials;
the stack comprises a superposition of sub-stacks each formed of three consecutive layers, the two layers on either side of the sub-stack being of the same material;
the material of a second layer has a mass fraction of self-contained purification agent greater than 0.15;
the material of a layer comprises a polycondensate of cyclodextrins;
the material of a layer comprises an ethylene-vinyl alcohol copolymer;
wherein the material of at least two layers in contact comprises a block copolymer, the block copolymer having a glass transition temperature below 0° C. and the material having a Young's modulus of less than 10 MPa;
the material of a layer comprises a styrenic thermoplastic elastomer;
the material of a layer is at least selected from glass and silicon;
a self-contained purification agent is adapted to capture the pollutant and is selected at least from a cyclodextrin, an activated carbon, a calixarene, activated alumina, a silica gel, graphite, a clay and a zeolite;
a self-contained purification agent is adapted to degrade the pollutant and is at least selected from a laccase, a horseradish peroxidase, a lignin peroxidase, a manganese peroxidase, a tyrosinase, potassium permanganate and a persulfate and a fungal enzyme;
at least one wall of a microfluidic channel has a plurality of reliefs extending in at least one direction different from the main direction of fluid flow;
the reliefs are in the form of striations and/or chevrons.

Another object of the invention is a purification assembly adapted to purify a fluid of at least one pollutant, comprising a plurality of fluidic devices, each fluidic device comprising a fluidic purification network, said fluidic purification network being a three-dimensional array of microfluidic channels, each microfluidic channel being defined by one or more fluid-tight walls, each microfluidic channel having at least one zone on the inner surface of said microfluidic channel having at least one self-contained purification agent and each microfluidic channel having at such a zone a height of less than 60 μm in a direction normal to the main direction of fluid flow, the self-contained purification agent or agents and the dimensioning of said zones being configured to allow a capture and/or degradation of at least 10% of the pollutants by said zones, for at least one flow of the fluid to be purified, the device comprising a plurality of distribution channels (40) and a plurality of collection channels (41), the fluidic purification network (8) connecting the distribution channels and the collection channels and being implemented at least by an array of microfluidic channels (9) connected in parallel, the fluidic devices being fluidly connected in series and/or in parallel.

Another object of the invention is a purification system comprising at least one fluidic purification device adapted to purify a fluid of at least one pollutant, each fluidic device comprising a fluidic purification network, said fluidic purification network being a three-dimensional array of microfluidic channels, each microfluidic channel being defined by one or more fluid-tight walls, each microfluidic channel having at least one zone on the inner surface of said microfluidic channel having at least one self-contained purification agent and each microfluidic channel having at such a zone a height of less than 60 μm in a direction normal to the main direction of fluid flow, the self-contained purification agent or agents and the dimensioning of said zones being configured to allow a capture and/or degradation of at least 10% of the pollutants by said zones, for at least one flow of the fluid to be purified, the device comprising a plurality of distribution channels (40) and a plurality of collection channels (41), the fluidic purification network (8) connecting the distribution channels and the collection channels and being implemented at least by an array of microfluidic channels (9) connected in parallel, the system also comprising a device for conditioning the temperature of a microfluidic channel.

The invention is advantageously complemented by the following features, taken individually or in any of their technically possible combinations:
the purification system is portable and/or electrically self-contained;
the system comprises at least one source of ultrasonic radiation.

Another object of the invention is a purification process adapted to purify a fluid of at least one pollutant, comprising a step in which the fluid is passed through a three-dimensional fluidic purification array of microfluidic channels at a flow rate of the fluid to be purified, each microfluidic channel comprising at least one zone on the inner surface of said microfluidic channel having at least one self-contained purification agent and each microfluidic channel having at such a zone a height of less than 60 μm in a direction normal to the main direction of fluid flow, the self-contained purification agent(s) and the dimensioning of said zones being configured to allow capture and/or degradation of at least 10% of the pollutants by said zones upon flow of the fluid at said flow rate through the array of microfluidic channels, the process comprising controlling a pressure difference between the inlet and outlet of a device so as to cause said fluid flow in said device, the device comprising at least one distribution channel connected to the inlet and at least one collection channel connected to the outlet, the fluidic purification network connecting the distribution channel or channels and the collection channel or channels, the hydrodynamic resistance of the distribution channel or channels and the collection channel or channels being strictly less than the hydrodynamic resistance of the fluidic purification network and the absolute value of the pressure difference being less than 5 bar.

The invention is advantageously complemented by the following features, taken individually or in any of their technically possible combinations:
a pressure difference between the inlet and the outlet of a device is controlled so as to cause said fluid flow in said device, the device comprising at least one distribution channel connected to the inlet and at least one collection channel connected to the outlet, the fluidic purification network connecting the distribution channel or channels and the collection channel or channels, the hydrodynamic resistance of the distribution channel or channels and the collection channel or channels being strictly less than the hydrodynamic resistance of the fluidic purification network and the absolute value of the pressure difference being less than 5 bar;
the flow rate is such that the Péclet number of the pollutant in the fluid stream flowing along the length of the purification zones in the direction of flow is less than 10⁴;
the fluid is recirculated in the microfluidic channels;
for the purification of a pollutant selected from a metallic element and an organic molecule having an octanol/water partition coefficient LogK_{ow}, greater than 1.5, the self-contained purification agent is a cyclodextrin and/or a cyclodextrin polycondensate;
the process comprises a step in which a washing and/or regeneration fluid is passed through the microfluidic channels.

Another object of the invention is a process for manufacturing a fluidic purification device adapted to purify a fluid of at least one pollutant, comprising a fluidic purification network, the fluidic purification network being a three-dimensional array of microfluidic channels, each microfluidic channel being defined by one or more fluid-tight walk, each microfluidic channel having at least one zone on the inner surface of said microfluidic channel having at least one self-contained purification agent and each microfluidic channel having at such a zone a height of less than 60 μm in a direction normal to the main direction of fluid flow, the self-contained purification agent(s) and the dimensioning of said zones being configured to allow capture and/or degradation of at least 10% of the pollutants by said zones, for at least one flow of the fluid to be purified, the fluidic device 1 comprising at least three stacked layers, at least two sides of one or more layers having, facing at least two layers, a depression pattern configured to form at least one two-dimensional array of microfluidic channels when the two layers are stacked, the material of each of the layers having a glass transition temperature below 0° C., the bonding between two layers being achieved solely by bringing the two layers into contact at a temperature between 0° C. and 50° C.

### Definitions

The term “pollutant” means any chemical and/or biological agent in a fluid that is at Least potentially toxic to humans and/or animals during use and/or consumption of that fluid, and particularly:
metallic cations such as Lead, cadmium, mercury, iron and copper cations;
oils and fats of mineral, animal, vegetable, marine or synthetic origin, including mixtures of petroleum hydrocarbons, antioxidants and antifreeze;
gaseous pollutants, such as volatile organic compounds (VOCs), including chlorinated compounds such as chlorobenzene, carbon tetrachloride and vinyl monochloride;
pollutants contained in drinking water, industrial water, hospital and agricultural effluents, for example herbicides, pesticides, endocrine disrupters, POPS and PPCPs, as described above and/or listed by the Stockholm Convention.

The term “purify”, in particular the term “purify a fluid of at least one pollutant” means the treatment to reduce the concentration of the pollutant in the fluid by at least 10%, preferentially by at least 40%, preferentially by at least 90% and preferentially by 100%.

A “purification agent” is any chemical and/or biological compound suitable for capturing and/or degrading a pollutant.

A “self-contained purification agent” is any purification agent that is capable of capturing and/or degrading a pollutant without physical stimulation external to the self-contained purification agent, such as light or electrical stimulation.

A “capturing agent” is any chemical compound, in particular any polymer, capable of trapping a substance or mixture of substances within its structure, immobilizing it and/or delaying its release to the outside.

“Channel length” is the size of a channel in the main direction of fluid flow.

“Channel width” is the maximum size of a channel in a direction transverse to the main direction of fluid flow.

“Channel height” is the minimum size of a channel in a direction transverse to the main direction of fluid flow.

A “tight” material is a material whose permeability to a fluid is less than 3000 bar at 25° C., i.e. 3000·10⁻¹⁰ cm_{STP}³·cm/cm²·s·cmHg at 25° C. where cm³_{STP} corresponds to the standard cubic centimeter, cm corresponds to the thickness of the material and cmHg corresponds to the pressure drop across the material.

The “abatement rate” is the proportion of pollutant purified by a remediation system in relation to the quantity initially introduced into the system.

A “two-dimensional array” of elements is a two-dimensional array in the strict sense, i.e. all the elements can be distributed in a plane, but not in a tine. More specifically, a “two-dimensional channel array” is an array of channels, preferably interconnected, in which each channel is distributed in the same plane, regardless of the orientation of each channel. Preferentially. the microfluidic channels of the purification network of the invention form at least one two-dimensional array of channels.

A “three-dimensional array” of elements is a three-dimensional array in the strict sense, i.e. all the elements can be distributed in space, but not in a plane. More specifically, a “three-dimensional channel array” is an array of channels, preferably interconnected, in which each channel is distributed in space but not in a plane, regardless of the orientation of each channel.

“Hydrodynamic resistance” means the ratio between the upstream/downstream pressure difference in a channel or more generally a channel system or pipe, and the volume flow rate of the fluid passing through the channel or more generally the channel system or pipe. This resistance can be measured by the flow of a liquid in the channel, even in the case of a purification of a gaseous fluid by the fluidic device. The hydrodynamic resistance can be calculated for water at 25° C.

### PRESENTATION OF THE FIGURES

Other features and advantages will also emerge in the following description, which is purely illustrative and non-limiting, and should be read in conjunction with the appended figures, among which:

FIG. 1 schematically illustrates a fluidic distribution network, a fluidic collection network and a fluidic purification network of a fluidic device;

FIG. 2 schematically illustrates the remediation of a pollutant in a microfluidic channel;

FIG. 3 schematically illustrates the fluidic distribution network connected to the fluidic connection network by an array of microfluidic channels;

FIG. 4 schematically illustrates a cross-section of a microfluidic channel connected to the fluidic distribution network and the fluidic connection network;

FIG. 5 schematically illustrates fluidic channels formed by the stacking of two layers;

FIG. 6 illustrates schematically different second layers;

FIG. 7 schematically illustrates the fluidic distribution network connected to the fluidic connection network by an array of microfluidic channels;

FIG. 8 schematically illustrates the fluidic distribution network connected to the fluidic connection network by an array of microfluidic channels;

FIG. 9 schematically illustrates the fluidic distribution network connected to the fluidic connection network by an array of microfluidic channels;

FIG. 10 schematically illustrates the arrangement of a part of the fluidic distribution network, a part of the fluidic connection network and a part of the fluidic purification network on a layer;

FIG. 11 schematically illustrates a stack of first and second layers;

FIG. 12 schematically illustrates a stack of first and second layers;

FIG. 13 schematically illustrates a fluidic device;

FIG. 14 schematically illustrates the distribution connector of a microfluidic device;

FIG. 15 schematically illustrates the collection connector of a microfluidic device;

FIG. 16 schematically illustrates the general architecture of a purification system;

FIG. 17 schematically illustrates a network of fluidic devices;

FIG. 18 schematically illustrates a fluidic purification process.

### DETAILED DESCRIPTION

### Theoretical Elements

The Stokes-Einstein relationship, described by formula (1), relates the diffusion coefficient D of a pollutant 3 in a fluid to its mobility μ, to the absolute temperature T and to the Boltzmann constant k_{B}.

D=μk_{B}T (1)

Unlike large-diameter pollutants, which can for example be removed from water by sedimentation, many micropollutants have a high diffusion coefficient. Lead, for example, has a diffusion coefficient of about 5·10⁻¹⁰ m²·s⁻¹ in water at 20° C.

Thus, in a confined environment, for example with a characteristic size of less than 100 μm and in a short time, for example less than 5 seconds, the pollutant 3 can meet the limits of the confined environment by diffusion with a high probability, for example more than 95%.

The Péclet number Pe (or Péclet mass number) is used to characterize the ratio between the transport of a pollutant 3 by convection and by diffusion, for example in a microfluidic channel. It can be defined by the formula (2):

$$P e = \frac{{L}_{c} \cdot v}{D} \qquad ( 2 )$$

where L_{c} is the characteristic length, and v is the advection velocity of the pollutant 3. The characteristic length is considered during the implementation of the invention to be equal to the length l′, i.e. the length of a zone 13 having self-contained purification agents within a microfluidic channel 4 in the main direction of fluid flow.

### General Architecture of the Device

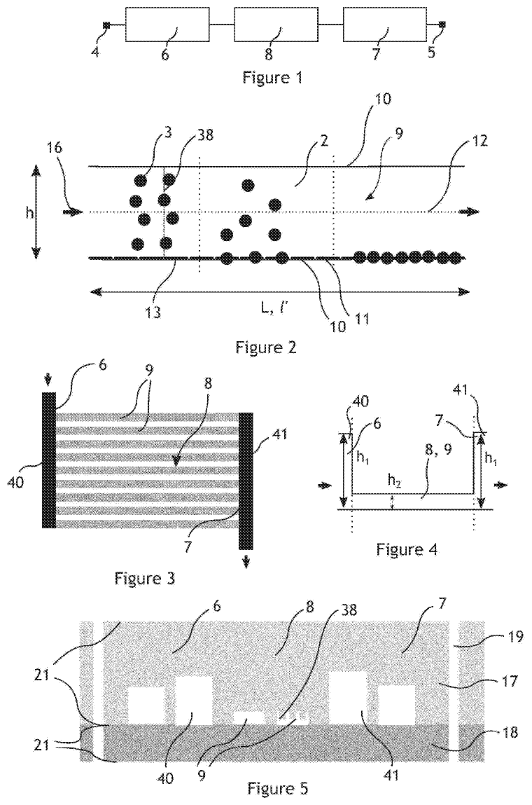

With reference to FIG. 1, the fluidic device 1 may comprise three connected fluidic networks. The inlet 4 of the device 1 is connected to a fluidic distribution network 6. The fluidic distribution network 6 distributes the fluid 2 to be purified to a fluidic purification network 8, to which it is fluidly connected. The fluidic purification network is a three-dimensional array of microfluidic channels 9, not shown in FIG. 1. The fluidic connection between the fluidic distribution network 6 and the fluidic purification network 8 can be a series connection, for example implemented by a plurality of outlets of the fluidic distribution network 6 connected to a plurality of inlets of the fluidic purification network 8 (not shown in FIG. 1). The fluidic purification network 8 is connected downstream to the fluidic connection network 7, allowing the purified fluid 2 to be collected by the fluidic purification network 8. The fluid connection between the fluidic purification network 8 and the fluidic connection network 7 can be a series connection, for example implemented by a plurality of outlets of the fluidic purification network 8 connected to a plurality of inlets of the fluidic connection network 7 (not shown in FIG. 1). The fluidic connection network 7 is connected downstream to the outlet 5 of the device.

### Remediation of a Pollutant

With reference to FIG. 2, a microfluidic channel 9 is adapted to purify a fluid 2 of at least one pollutant 3. FIG. 2 shows a cross-section of the microfluidic channel 9. The microfluidic channel 9 has a height h and length L. The microfluidic channel 9 is formed by one or more walls 10 fluid-tight to the fluid 2. When introduced into the microfluidic channel 9, a fluid 2 may have pollutants 3 throughout a cross-section 38 of the microfluidic channel 9 relative to a main direction of flow of the fluid 12 of flow of the fluid 2. This state of the fluid 2 is shown in the left-hand side of the microfluidic channel 9 in FIG. 2.

The microfluidic channel 9 has a zone 13 on the inner surface of said microfluidic channel, with self-contained purification agents 11. For example, this zone 13 may correspond to a wall 11 with a self-contained purification agent 11 within the microfluidic channel 9, illustrated in FIG. 1 by a thick, discontinuous line on the lower wall 10 of the channel. The self-contained purification agent 11 is present over a length l′ of the zone 13 of the microfluidic channel 9. The diffusion of the pollutants 3 in a direction transverse to the main direction of flow of the fluid 12 allows, after a given time spent in the channel, or after a length traversed by the flow 16, a pollutant 3 to meet the part of the wall 10 on which the self-contained purification agent 11 is presented. Table 1 shows the time required for the diffusion, in particular lateral diffusion, of different pollutants over a series of specified characteristic distances.

TABLE 1

| | Diffusion | | | | | | | |
|---|---|---|---|---|---|---|---|---|
| | coeffi- | | | | | | | |
| | cients D | Diffusion time in water at 20° C. | | | | | | |
| Pollutants 3 | m² · s⁻¹ | 1 cm | | 1 mm | | 100 μm | | 10 μm |
| Carbamazepine | 4 · 10⁻¹⁰ | 6.9 | h | 4.2 | min | 2.5 | s | 0.03 s |
| (CBZ, | | | | | | | | |
| Tegretol) | | | | | | | | |
| Diuron | 5 · 10⁻¹⁰ | 5.6 | h | 3.3 | min | 2.0 | s | 0.02 s |
| Chlordecone | 2 · 10⁻¹⁰ | 138.9 | h | 83.3 | min | 50.0 | s | 0.50 s |
| Heavy metals | 10⁻⁹ | 27.8 | h | 16.7 | min | 10.0 | s | 0.10 s |
| (low limit) | | | | | | | | |
| Heavy metals | 10⁻¹⁰ | 277.8 | h | 166.7 | min | 100 | s | 1.00 s |
| (high limit) | | | | | | | | |

Thus, as shown in the central part of FIG. 1, some of the pollutants 3 interact with the self-contained purification agents 11 present on the wall. This interaction may consist of capture, as shown in FIG. 2, or degradation of the pollutants 3. Another portion of the pollutants 3 is always present in the fluid 2. In general, the interaction of the pollutants 3 with the self-contained purification agents 11 results in a depletion of the pollutants 3 in the fluid 2, without impeding the flow 16. Thus, the fluid 2 can be purified of the pollutants 3 after having travelled the length V in the channel, as shown in the right-hand part of the microfluidic channel 9 in FIG. 2.

For example, for pollutants 3 such as carbamazepine, diuron, chlordecone and some heavy metals, the time required to interact with a self-contained purification agent 11 is less than one second in a microfluidic channel 9 with a height of 10 μm. In comparison, this time is of the order of 100 minutes and several hundred hours in channels with a height of 1 mm and 1 cm respectively. The quadratic reduction of this time with the height of the microfluidic channel 9 makes a purification of the fluid 2 possible by diffusion.

Thus, the flow of the fluid 2 in the confined microfluidic channels 9 with a height of less than 100 μm, preferentially 80 μm and preferentially 60 μm, purifies the fluid 2 by taking advantage of the effects of the diffusion of the pollutants 3, which, in known methods, has a purifying effect only in a negligible volume of the fluid 2.

The fluidic purification network 8 is a three-dimensional array of microfluidic channels 9, each microfluidic channel 9 having at least one self-contained purification agent 11 inside the microfluidic channel 9. Thus, it is possible to run the purification implemented by a single microfluidic channel 9 in parallel in order to achieve a flow rate compatible with industrial applications, for example greater than 10 L/h and preferentially 1000 L/h, contrary to the prejudices of the prior art (Wang et al., IV, Discussion, “[it] may not be used directly for practical water purification application”). In all the embodiments of the invention, the purification agent(s) 11 being self-contained, no light stimulation (or more generally no external stimulation) is required to capture and/or degrade a pollutant 3. Thus, it is possible to make the microfluidic channels 9 parallel in each dimension of space, regardless, for example, of the light absorption of the material forming the microfluidic channels 9.

With reference to FIG. 3, a part of the fluidic distribution network 6, in particular at least one distribution channel 40, and preferentially a plurality of distribution channels 40, can be connected to a part of the fluidic collection network 7, in particular at least one collection channel 41, preferentially a plurality of collection channels 41, via a part of the fluidic purification network 8 implemented by an array of parallel microfluidic channels 9. A distribution network comprises at least one distribution channel 40. A collection network comprises at least one collection channel 41. FIG. 3 shows a top view of part of the different fluid networks. The fluid flow 2 to be purified is represented by the arrow in the upper right-hand corner of FIG. 3. The fluid 2 can thus be distributed in all the microfluidic channels 9 and leave purified in the fluidic connection network 7. In general, the zones 13 are dimensioned to allow the self-contained purification agents a capture and/or degradation of at least 10%, preferentially at least 40%, preferentially at least 90% and preferentially 100% of the pollutants 3. This dimensioning can be implemented by adjusting the length l′ of the zones 13 in the main direction of the flow 12 and/or by adjusting the number of walls on which the self-contained purification agents 11 will be presented. For example, if the fluid is insufficiently purified of the pollutants 3 after passing through a purification device, a higher zone 13 length l′ can be selected when manufacturing the device 1 in accordance with the invention.

With reference to FIG. 4, the channels of the different networks of the fluidic device 1 may have different heights. In general, the hydrodynamic resistance of the distribution channel(s) 40 and the collection channel(s) 41 is strictly lower than the hydrodynamic resistance of the fluidic purification network 8. Preferentially, the hydrodynamic resistance of the distribution channel(s) 40 and the collection channel(s) 41 is negligible compared to the hydrodynamic resistance of the fluidic purification network 8. The microfabrication of channels with different heights can be used to adjust the different hydrodynamic resistances of different fluid networks. FIG. 4 shows a cross-section of the portion of the networks shown in FIG. 3. The part of the fluidic distribution network 6 and the part of the fluidic collection network 7 have a height h₁ greater than the height h₂ presented by a microfluidic channel 9. Thus, it is possible to impose a higher fluid flow rate to drive a flow 16 than by using a fluidic device whose hydrodynamic resistances of each network would be equal.

The length of the distribution channel(s) 40 and/or the collection channel(s) 41 may be between 0.4 cm and 40 cm, preferentially between 2 cm and 10 cm and preferentially between 4 cm and 6 cm. The width of the distribution channels) 40 and/or the collection channel(s) 41 may be between 10 μm and 1 mm, preferentially between 50 μm and 200 μm and preferentially between 100 μm and 150 μm. Finally, the height of the distribution channel(s) 40 and/or the collection channel(s) 41 may be between 50 μm and 500 μm, preferentially between 100 μm and 300 μm and preferentially between 150 μm and 200 μm. The length of the microfluidic channels 9 of the fluidic purification network 8 can be between 50 μm and 100 mm, preferentially between 500 μm and 10 mm and preferentially between 1 mm and 3 mm. The width of the microfluidic channels 9 can be between 10 μm and 1 mm, preferentially between 50 μm and 200 μm and preferentially between 100 μm and 150 μm. The height of the microfluidic channels 9 of the fluidic purification network 8 can be between 1 μm and 500 μm, preferentially between 5 μm and 100 μm and preferentially between 10 μm and 60 μm. A microfluidic channel 9 can have several heights: a wall of the microfluidic channel 9 can, for example, have chevron-shaped reliefs.

With reference to FIG. 5, the different arrays can be formed by contacting one side 21 of a first layer 17 and one side 21 of a second layer 18, each layer having two sides 21. FIG. 5 shows a fluidic device 1, in section view, in which a part of the fluidic distribution network 6, a part of the fluidic collection network 7 and a part of the fluidic purification network 8 are formed by bringing a first layer 17 and a second layer 18 into contact. One side 21 of the first layer 17 has a depression pattern configured to form on contact between the two layers at least one two-dimensional array of microfluidic channels 9, and preferentially a part of the different networks allowing the flow and purification of the fluid 2.

A first layer 17 can for example be made of thermoplastic elastomeric material (for example polystyrene-b-poly(ethylene-butylene)-b-polystyrene or SEBS, of polystyrene-b-polybutadiene-b-polystyrene or SBS, of syndiotactic polystyrene or SPS, of Kraton, registered trademark, or of Flexdym).

A second layer 18 may for example comprise a mixture of multiphase polymers of ethylene and vinyl alcohol (EVOH) and polycondensate of cyclodextrin(s) (PCCD), a thin layer of polypropylene, SEBS, SBS, SPS, Kraton (registered trademark) or Flexdym (registered trademark). A second layer 18 can also be partially functionalized by fungal laccases.

In general, a layer 17,18 can also be made of PDMS, PFPE, PMMA or any other known material suitable for microfabrication of microfluidic channels 9.

The fluidic device 1 may comprise one comprising at least one primary channel passing through a plurality of adjacent layers to open respectively into at least one distribution channel 40 and/or at least one collection channel 41 formed between two layers 17, 18. Aligned apertures through the different adjacent layers may form a primary channel 19. It is possible to compare a primary channel 19 with a via structure in microelectronics by analogy between the electric current and the flow of the fluid 2. A primary channel 19 can be included in the fluidic distribution network 6, and allow fluid 2 to be routed to the part of the fluidic distribution network 6 at the interface of a first layer 17 and a second layer 18. A primary channel 19 can also be included in the fluidic collection network 7 and allow the purified fluid 2 to be discharged from the part of the fluidic collection network 7 at the interface of a first layer 17 and a second layer 18. In general, a primary channel 19 can fluidly connect all parts of the fluidic distribution network 6 and/or all parts of the fluidic connection network 7.

The area of a section of a primary channel 19, normal to the main direction of flow, may be between 0.01 mm² and 100 mm², preferentially between 0.1 mm² and 10 mm² and preferentially between 0.8 mm² and 5 mm².

FIG. 5 also shows two different sections of microfluidic channels 9 of the fluidic purification network 8. The sections shown are cross sections of the main directions of flow 12 of the fluid. The section of the microfluidic channel 9 shown on the left of the fluidic purification network 8 is rectangular. This section corresponds to the microfluidic channel 9, the cross-section of which is shown in FIG. 1, The section shown to the right of fluidic purification network 8 shows reliefs 38 along its upper edge. Reliefs on a wall of the microfluidic channel 9 preferentially have an orientation different from the main direction of flow 12, inside the channel, adapted to cause convection of the fluid 2 in the microfluidic channel 9 in a direction different from the main direction of flow 12. Thus, a fluid, layer 2 depleted in pollutants 3, for example near a wall 10 with a self-contained purification agent 11, can be replaced by convection along an axis transverse to the flow by a fluid layer 2 not depleted in pollutants 3. The efficiency of the purification of pollutant 3 can thus be increased. In particular, a wall may have reliefs selected from striations or chevrons.

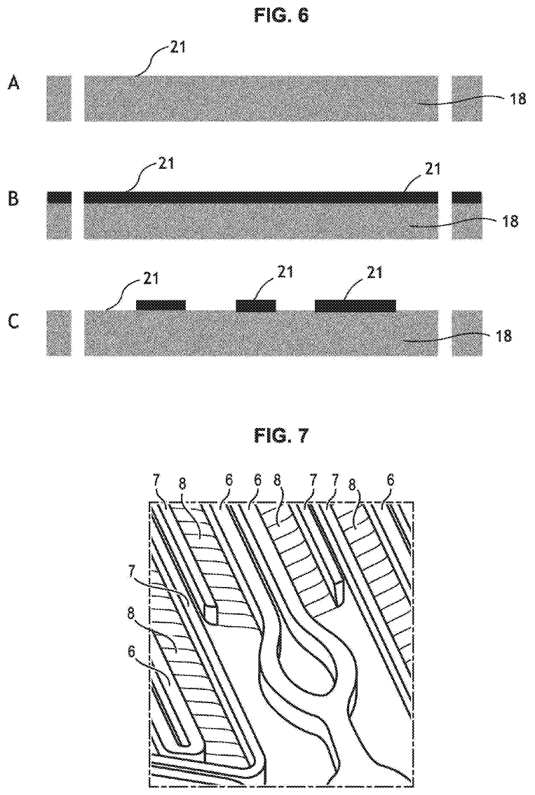

With reference to FIG. 6, the wall 10 of a microfluidic channel 9 may have a self-contained purification agent 11 on the surface of the wall 10,

Panel A in FIG. 6 shows a second layer 18, which is used to form part of the fluid networks as shown in FIG. 5. The material of the second layer 18 may include self-contained purification agent 11: the self-contained purification agent 11 may be distributed in another matrix material, or it may simply be the second layer 18 material itself.

Preferentially, the second layer 18 is made using a polycondensate of cyclodextrin(s), or a composition comprising at least one polycondensate of cyclodextrin(s) obtained by the reaction of the following compounds (A) to (C):

(A) at Least one cyclodextrin,

(B) at Least one Linear, branched and/or cyclic, saturated, unsaturated or aromatic polycarboxylic acid, and (C) at least one thermoplastic polymer polyol. The thermoplastic polymer polyol (C) is a copolymer of ethylene and vinyl alcohol (EVOH) and the polycondensate of cyclodextrin(s) thus obtained, or a composition comprising at least this polycondensate of cyclodextrin(s), is the self-contained purification agent 11 present on the surface of the second layer 18 and on the surface of a wall 10.

The term “polycondensate” refers to any polymer obtained by stepwise polymerization, where each step is a condensation reaction, which is carried out with removal of water, Monomers with two or more functional groups react to form first dimers, then longer trimers and oligomers, and then tong-chain polymers. The polycondensate of cyclodextrin(s) has a porous network which combines super-absorbent sponge-like properties with the ability to form inclusion complexes in the cavities of the cyclodextrin(s) immobilized within the polymer network, thereby allowing the capture of substances having an affinity with said polymer network. The polycondensate of cyclodextrin(s) allows the capture of, for example, metals or metallic elements, noted M, in their oxidation state 0 (M(0)), as well as substances such as medicines and pesticides. The polycondensate of cyclodextrin(s) is also obtainable by the reaction of the following compounds (A) to (C): (A) at least one cyclodextrin, (B) a linear or branched saturated aliphatic polycarboxylic acid, and (C) a copolymer of ethylene and vinyl alcohol (EVOH). The cyclodextrin (A) used is a compound of general structure (3) below, or one of the derivatives of this compound such as methyl, hydroxyalkyl, sulfoalkyl, sulfate or sugar-substituted cyclodextrins:

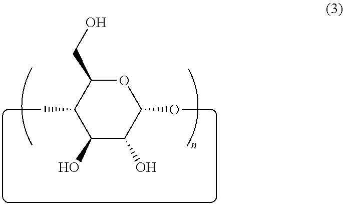

The cyclodextrin (A) can be selected from α-cyclodextrin, β-cyclodextrin and γ-cyclodextrin. The polycondensate of cyclodextrin is obtained by the reaction of compounds (A) to (C) using only a cyclodextrin (A). The polycondensate of cyclodextrins can also be obtained by the reaction of compounds (A) to (C) using a mixture of cyclodextrins (A), for example a mixture of two, three or more cyclodextrins (A). When this mixture of cyclodextrins (A) comprises two cyclodextrins, one of these two cyclodextrins is advantageously the β-cyclodextrin. Such a mixture of cyclodextrins (A) may in particular comprise, relative to the total mass of the said mixture, the following proportions by mass:
10% to 60% of β-cyclodextrin, and
40% to 90% of α-cyclodextrin or γ-cyclodextrin.

In this particular mixture of two cyclodextrins (A), the mass proportion of β-cyclodextrin can advantageously be between 20% to 50% and preferentially between 25% to 40% of the total mass of the cyclodextrin mixture. In this particular mixture of two cyclodextrins (A), the proportion by mass of β-cyclodextrin or γ-cyclodextrin may be between 50% and 80% and preferentially between 60% and 75% of the total mass of said mixture of cyclodextrins.

The compound (B) used may be a linear, branched or cyclic, saturated, unsaturated or aromatic polycarboxylic acid. Such polycarboxylic acid(s), which comprise at least two carboxyl groups —COOH, may be linear, branched and/or cyclic. They can also be saturated, unsaturated or aromatic. This or these polycarboxylic acid(s) may comprise from 2 to 50, advantageously from 3 to 36, preferentially from 4 to 18 and even more preferentially from 4 to 12 carbon atoms. Compound (B) may, for example, be a saturated linear or branched aliphatic polycarboxylic acid, and/or selected from malic acid, citric acid, aconitic acid, 1,2,3-propanetricarboxylic acid, 1,2,3,4-butanetetracarboxylic acid, oxydisuccinic acid and thiodisuccinic acid. The compound (C) is a copolymer of ethylene and vinyl alcohol, known by the abbreviation EVOH. The polycondensate of cyclodextrin(s) used may be in the form of a solid compound that can be advantageously processed, for example in the form of pebbles, granules, powder or nanotubes. Being a solid compound, the polycondensate of cyclodextrin(s) can also be molded. The polycondensate of cyclodextrin(s) is obtainable by the reaction of the following compounds (A) to (C): (A) at least one cyclodextrin, (B) at least one linear, branched and/or cyclic, saturated, unsaturated or aromatic polycarboxylic acid, and (C) at least one copolymer of ethylene and vinyl alcohol (EVOH). In addition, the composition may include one or more other compound(s), which may impart properties complementary to those of the polycondensate of cyclodextrin(s), such as magnetic properties. Such compounds may include activated carbon, paints, magnetic compounds and antibacterial agents (for example silver or copper microparticles). Thus, this polycondensate of cyclodextrin(s) alone, or in admixture with one or more other compounds in a composition, enables a substance or a mixture of substances to be trapped within its structure, to immobilize it and/or to delay its release to the outside.

The polycondensate of cyclodextrin(s) and/or the composition comprising one or more polycondensate of cyclodextrin(s) can be used as a capture agent for at least one substance selected from a metallic element and an organic molecule.

Where the substance is a metallic element, this metallic element M may in particular be selected from aluminum, silver, iron, boron, tin, copper, zinc, lead, nickel, cadmium, chromium, mercury and gold.

When the substance is an organic molecule, this organic molecule has an octanol/water partition coefficient, denoted LogK_{ow} greater than or equal to 1.5. The polycondensate of cyclodextrin(s) and the composition can be used as a capture agent for at least one organic molecule having a LogK_{ow}, of between 1.5 and 10 and preferentially between 5 and 8.

The pollutant 3 may be an organic molecule chosen from a herbicide such as diuron, a drug, for example an anticonvulsant drug such as carbamazepine, an endocrine disruptor such as polychlorinated biphenyls (PCBs or pyralenes), phthalates and polycyclic aromatic hydrocarbons (PAHs) such as benzopyrene, these organic molecules being known to be particularly difficult to clean up environments containing them.

In particular, the polycondensate of cyclodextrin(s) according to the invention is particularly effective as a capture agent for the congeners of polychlorinated phenyls known by the abbreviations PCB 28, PCB 52, PCB 101, PCB 118, PCB 138, PCB 153 and PCB 180.

Alternatively, the polycondensate is obtainable by the reaction in which the compound (A) is selected from hydroxypropyl-β-cyclodextrin (HPCD), methyl-β-cyclodextrin (MCD) and carboxymethyl-β-cyclodextrin (CMCD).

Panel B in FIG. 6 shows a second layer 18 comprising a thin layer of self-contained purification agents 11 forming one of the sides 21 of the second layer 18. The material of the thin layer may be similar to the material of the second layer described in Panel A of FIG. 6. A thin layer of self-contained purification agents 11 is also referred to as a layer with surface modifications of the second layer 18. For example, it is possible to adsorb the self-contained purification agents 11 on the surface of the second layer 18 and/or to graft the self-contained purification agents 11 by covalent grafting, for example by photo grafting. The material of the second layer 18 can be chosen for example from polycarbonate, polystyrene, EVOH, polyether-ether-ketone (PEEK), styrene-based elastomeric thermoplastics and fluorinated materials, Fungal laccases can be immobilized as a self-contained purification agent 11 on polypropylene or polyaniline polymers. Other materials such as glass, silicon, ceramics and/or metals can be used, which can be used to purify a fluid 2 under high pressure and/or temperature conditions, or to purify fluids 2 in the organic liquid phase.

Panel C in FIG. 6 shows a second layer 18 comprising a thin layer of self-contained purification agents 11 arranged in a pattern on the side 21 of the second layer 18. The methods for the deposition of self-contained purification agent 11 described above can be coupled with techniques such as microcontact printing, UV lithography or printing technologies to achieve the patterns.

### Parallelization

The parallelization of the microfluidic channels 9 increases the total flow of the fluidic device 1. With reference to FIG. 7, the fluidic purification network 8 connects the fluidic distribution network 6 and the fluidic connection network 7. A plurality of microfluidic channels 9 are connected in parallel, by the fluidic distribution network 6 and by the fluidic collection network 7, i.e. respectively by a plurality of distribution channels 40 and by a plurality of collection channels 41. FIG. 7 shows a fluidic purification network 8 comprising a series of parallel microfluidic channels 9 arranged between channels of the fluidic distribution network 6 and the fluidic collection network 7. The microfluidic channel series 9 are illustrated by the white surfaces. The microfluidic channels 9 are arranged parallel to the black arrows indicating the direction of fluid flow 2. It is typically possible to arrange on a layer 19152 microfluidic channels 9 with length L=750 μm, width W=360 μm and height h=10 μm.

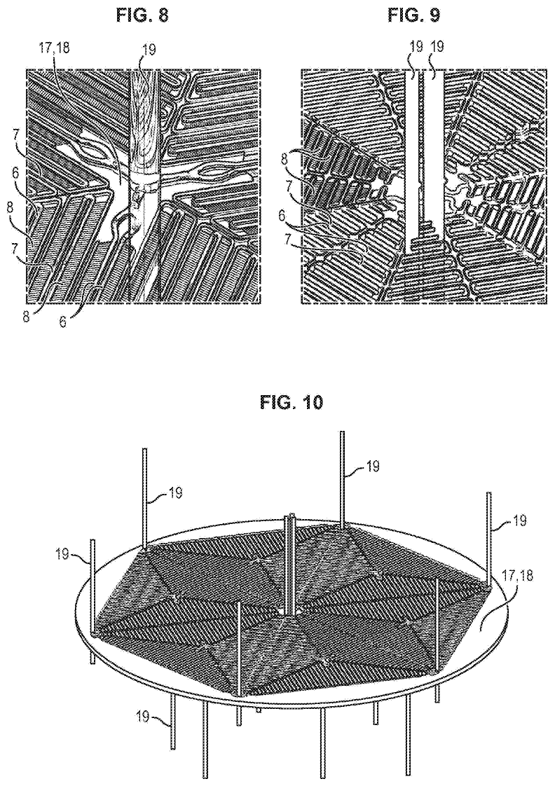

With reference to FIG. 8 and to FIG. 9, a radial architecture can be used to arrange part of the fluidic distribution network 6, part of the fluidic connection network 7 and part of the fluidic purification network 8 at the interface between a first layer 17 and a second layer 18. The fluidic distribution network 6 may include a primary channel 19. The primary channel 19 is used to fluidically connect the inlet 4 of the fluidic device 1 to a part of a fluidic distribution network 6 arranged on a first layer 17. The primary channel 19 can be produced by micromachining, for example by a milling machine, by laser, by a wet etching and/or dry etching process (particularly for a first layer 17 and/or a second layer 18 of silicon or glass), by hot lithography (particularly for a first layer 17 and/or a second layer 18 of styrene-ethylene styrene triblock copolymers). It is also possible to manufacture a primary channel 19 by 3D printing.

With reference to FIG. 10, a radial architecture can be used to arrange a part of the fluidic distribution network 6, a part of the fluidic connection network 7 and a part of the fluidic purification network 8 at the interface between a first layer 17 and a second layer 18. FIG. 10 illustrates the implementation of such an architecture on a first layer 17 or on a second layer 18. The part of the fluidic distribution network 6 arranged on the layer is connected upstream to 9 primary channels 19. The part of the fluidic collection network 7 is connected downstream to 6 primary channels 19,

The surface occupied, in the projection onto the principal plane of the interface between two superimposed layers, by the distribution channel or channels 40 and by the collection channel or channels 41 on the side of a layer is advantageously between 20% and 45% of the total surface of said side, preferentially between 6% and 25% of the total surface of said side and preferentially between 13% and 17% of the total surface of said side.

The surface area occupied, in the projection onto the principal plane f the interface between two superimposed layers, by the microfluidic channel or channels 9 on the side of a layer is advantageously between 20% and 70% of the total surface area of said side and preferentially between 40% and 50% of the total surface area of said side.

Thus, the layout of the fluidic distribution network 6, the fluidic collections network 7 and the fluidic purification network 8 is optimized to meet two criteria: on the one hand, to minimize the ratio between the hydrodynamic resistance of the fluidic distribution network 6 and the fluidic collection network 7 in relation to the hydrodynamic resistance of the fluidic purification network 8, and on the other hand, to maximize the surface density occupied by the fluidic purification network 8 on a layer.

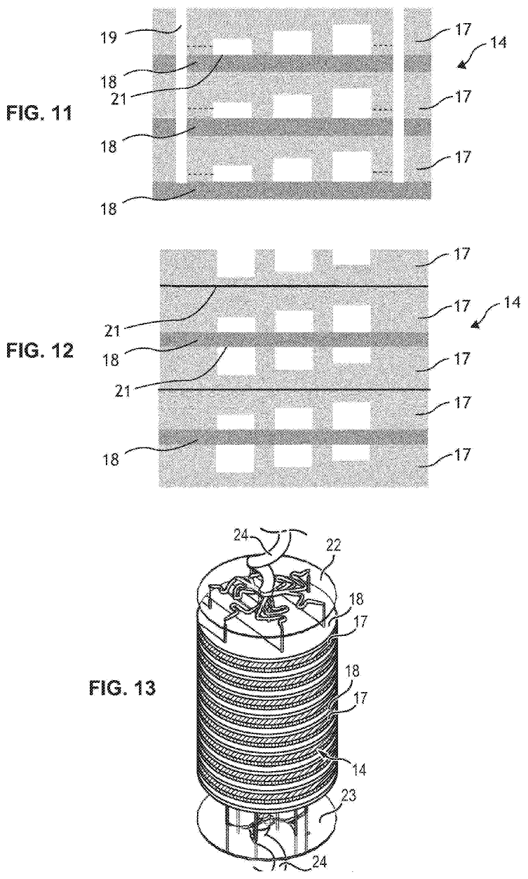

With reference to FIG. 11, the parallelization of microfluidic channels 9 can be implemented by superimposing two-dimensional arrays of microfluidic channels 9, the fluidic purification network 8 connecting the distribution channels 40 and the collection channels 41. Sub-stacks consisting of a first layer 17 and a second layer 18 can be stacked. FIG. 11 shows a stack 14 comprising an alternating superposition of first layers 17 and second layers 18. Stacking 14 and gluing are carried out on the side 21 of the layers. The bonding or sealing of the individual layers can be achieved by treating the sides 21 of the layers with plasma, for example oxygen plasma. It is also possible, when the material of each layer has a glass transition temperature below 0° C., to bond two layers only by bringing the two layers into contact at a temperature between 0° C. and 50° C. When the layers are bonded together by contact bonding, the material of the layers preferentially has a Young's modulus of less than 10 MPa: thus, side 21 of one Layer is deformable enough to come into contact with side 21 of another layer despite the potential irregularities present on the sides 21. The material Flexdym (registered trademark) allows this type of bonding at room temperature between two layers. For example, it is possible to glue or seal different layers of a stack 14 without conditioning the stack 14 at temperatures that cause denaturation of biological species used as self-contained purification agents 11. Enzymes, particularly fungal laccases, when used as a self-contained purification agent 11, can be presented to the watt 10 of a microfluidic channel 9 without being denatured by a prior manufacturing step.

The thickness of the first layers 17 can be between 0.05 mm and 1 cm, preferentially between 0.5 mm and 2 mm and preferentially between 1 mm and 1.5 mm.

The primary channels 19 make it possible, in the case of a stack 14 of several first layers 17 and several second layers 18 to distribute or collect the fluid 2 in the channels present at each interface between a first layer 17 and a second layer 18. The dashed tines show channels at the interface of the two layers 17, 18 allowing the primary channels 19 to be connected to the other channels at the interface.

With reference to FIG. 12, both sides 21 of the same second layer 18 can be used to form fluid arrays by bringing into contact on either side of the second layer 18 first layers 17 having on the side 21 brought into contact a depression pattern, A sub-stack can thus be formed, formed consecutively from a first layer 17, a second layer 18 and a first layer 17. Thus, if the second layer 18 has purification properties on both sides 21, as is the case for a second layer 18 made of PCCD/EVOH, the number of second layers 18 used in a stack 14 for a fluid array of the same size is minimized, it is possible to use block copolymer materials with a glass transition temperature below 0° C. as described above to seal two layers, for example a first layer 17 and a second layer 18, at room temperature without any further processing step than bringing the individual layers into contact.

In general, at Least three layers are stacked, at least two sides of one or more layers having, facing at least two layers, a depression pattern configured to form at least two two-dimensional arrays of microfluidic channels when the at least three layers are stacked. Thus, it is possible to parallelize the two-dimensional arrays of microfluidic channels 9 formed between two layers so as to form a three-dimensional array of micro-fluidic channels 9. Thus, the high degree of parallelization of the microfluidic channels 9 makes it possible to reduce the hydrodynamic resistance of the fluidic purification network 8 and thus to circulate fluid 2 by controlling or monitoring the system and/or the purification network 8 with a pressure variation between inlet and outlet of less than 5 bar, and preferentially less than 1 bar.

With reference to FIG. 13, a stack 14 of layers may include a distribution connector 22 and a collection connector 23 at the ends of the stack 14. These manifolds may have recessed patterns, channels and/or apertures to connect an inlet or outlet connector 24 of the fluidic device 1 to the primary channels 19 of the fluidic device 1. FIG. 13 shows a stack 14 comprising a succession of alternating first layers 17 and second Layers 18 between a distribution connector 22 and a collection connector 23. In stack 14, the different layers and connectors are in contact: FIG. 13 is an exploded view of the fluidic device 1.

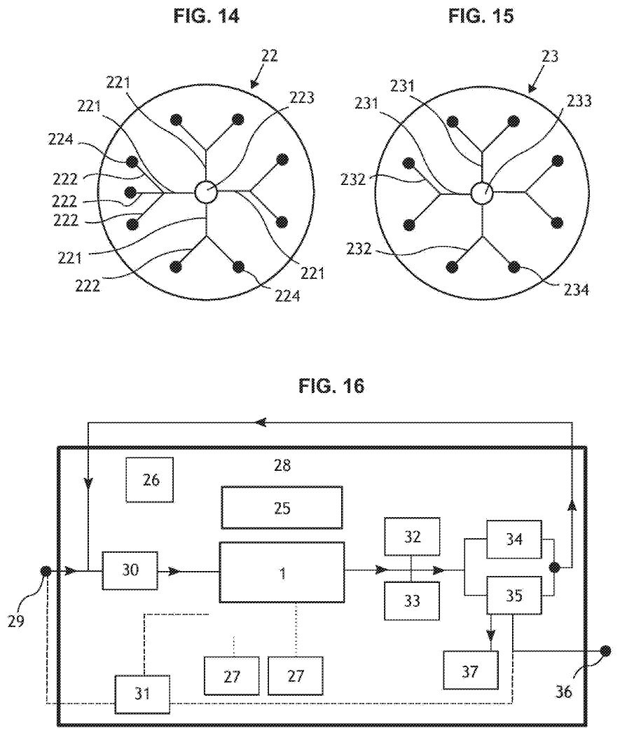

With reference to FIG. 14, the distribution connector 22 can be adapted to form channels connecting an inlet fluidic connector 24 to different primary circuits 19. FIG. 14 shows a top view of a distribution connector 22. One inlet of the distribution connector 223 can be adapted to be connected to a fluidic connector 24 (not shown). By contacting the distribution connector 22 with a layer, fluid channels can be formed, including first generation channels 221, which are fluidly connected to the inlet of the distribution connector 223. FIG. 14 shows a pattern adapted to form 4 first generation channels 221. Preferentially, the fluidic device 1 comprises between 2 and 50 first generation channels 221, preferentially between 3 and 25 first generation channels and preferentially between 4 and 10 first generation channels. Each of the first generation channels 221 can be connected to second generation channels 222, connecting the first generation channels 221 to the outlets of the distribution connector 224. Each outlet of the distribution connector 224 is adapted to be connected to a primary channel 19. The distribution connector 22 may also comprise two layers forming the different channels connecting the input of the distribution connector 223 to the outlets of the distribution connector 224. The distribution connector 22 can be sealed or bonded to a layer by one of the methods described above. It can also be stuck to a layer using double-sided adhesive tape.

With reference to FIG. 15, the collection connector 23 can be adapted to form channels connecting a fluidic outlet connector 24 to different primary circuits 19. FIG. 15 shows a top view of a collection connector 23. One outlet of the distribution connector 233 can be adapted to be connected to a fluidic connector 24 (not shown). By contacting the collection connector 23 with a layer, fluid channels can be formed, including first generation channels 231, which are fluidly connected to the outlet of the distribution connector 233. FIG. 14 shows a pattern adapted to form 4 first generation channels 231. Preferably, the fluidic device 1 comprises between 2 and 50 first generation channels 231, preferentially between 3 and 25 first generation channels 231 and preferentially between 4 and 10 first generation channels 231. Each first generation channel 231 can be connected to second generation channels 232, connecting the first generation channels 231 to the inputs of the collection connector 234. Each input of the collection connector 234 is adapted to be connected to a primary channel 19. The collection connector 23 may also include two layers forming the different channels connecting the outlet of the collection connector 233 to the inputs of the collection connector 234. The collection connector 23 can be sealed or bonded to a layer by one of the methods described above to seal the layers together. It can also be stuck to a layer using double-sided adhesive tape.

The distribution connector 22 and collection connector 23 can be made of polydimethylsiloxane (PDMS) and produced by soft lithography. They can also be made of thermoplastic elastomers and structured by hot printing lithography, injection molding, 3D printing, or stereolithography. Materials such as polystyrene, polycarbonate, polyimide or other thermoplastic elastomeric materials such as polyurethane or blockamide materials can also be used. The distribution connector 22 and collection connector 23 can also be made of silicon, glass or metallic material (for example Ni, NiCo alloy, aluminum, stainless steel): thus, the fluidic device 1 can mechanically and chemically resist an organic fluid flow 2. The distribution connector 22 and collection connector 23 can be manufactured, using these materials, by 3D printing, micromachining, electroplating, wet etching and/or reactive ion etching.

### Washing and Regeneration of the Fluidic Device 1

Washing fluids and/or regeneration fluids for the self-contained purification agents can be introduced into the fluidic device 1. Washing fluid means a fluid for removing impurities trapped in a fluidic device 1. Regeneration fluid means a fluid that allows the release of the pollutants 3 captured by the self-contained purification agents 11, or allows the self-contained purification agents 11 to degrade the pollutants 3 with an efficiency substantially equal to the sensitivity to the initial time at which the fluid 2 is introduced into the fluidic device 1. A combination of cleaning and regeneration fluids can be introduced into the fluidic device 1, for example at a flow rate between 0.01 μL/min and 250 L/min, preferentially between 1 μL/min and 2 L/min, and preferentially between 0.7 mL/min and 3 mL/min. A flow of washing and/or regeneration fluid can be coupled with thermal conditioning. For example, the temperature of the fluid 2 can be conditioned before it is introduced into a fluidic device 1. The circulation of washing and/or regeneration fluid may be discontinuous, open or closed Loop. A 5% citric acid solution can be used as a washing and regeneration solution. An oxidizing O₂ plasma can also be used. This plasma can circulate, in a closed Loop, at a flow rate between 0.1 μL/min and 0.5 μL/min.

The washing and/or regeneration fluids may be recirculated in the same direction or in, the opposite direction to the flow of the fluid 2. In addition, the circulation and/or recirculation of the washing and/or regeneration fluid may be pulsed, i.e. the flow rate is periodic and variable, for example in slots.

### General Architecture of a Purification System

FIG. 16 schematically illustrates the general architecture of a purification system. The system comprises a frame 28, which includes at least one fluidic device 1. The frame may include a source of ultrasonic radiation. The housing can be made of polymer or metallic material, allowing the system to be used at high temperatures, for example between 50° C. and 250° C., and/or to block the radiation emitted by the radiation source 25 to the outside of the frame 28. The source 25 is used to purify the fluid 2 flowing through the fluidic device 1 in addition to and separately from the sanitization by diffusion/convection.

A temperature conditioning device 27 is adapted to condition the temperature inside the frame 28. Another temperature conditioning device 27 can be adapted to condition the temperature of the fluidic device 1. The temperatures of the frame and/or fluidic device 1 can be adjusted by the temperature conditioning devices between 20° C. and 250° C. For example, temperature conditioning devices may include temperature sensors to maintain a setpoint temperature by closed-loop temperature control. Thus, it is possible to adjust the purification efficiency of the fluid 2 passing through the fluidic device 1: according to the Stokes-Einstein equation, the diffusion constant of a pollutant 3 changes Linearly with temperature. An increase in temperature thus makes it possible to increase the speed at which a pollutant 3 is likely to encounter a wall with a self-contained purification agent 11.

A pump 30 is used to control the flow 16 of the fluid 2 in the purification system. Pump 30 is suitable to drive a fluid flow rate in the purification system between 0.01 μL/min and 2500 L/min.

A pressure controller 31 can control a pressure inside the frame 28 whose absolute value is less than 5 bar and preferentially less than 1 bar. A pressure controller can also be adapted to control a fluid flow rate by pressure difference in the fluidic device 1. The pressure difference between inlet and outlet can be negative to attract the fluid 2 to the outlet or positive to push the fluid 2 to the outlet.

A first fluidic detection unit 32 can be fluidly connected downstream of the fluidic device 1. The fluidic detection unit 32 can measure the pollutant concentration 3 of the fluid 2 at the outlet of the fluidic device 1.

A second fluidic detection unit 33 can be fluidly connected downstream of the fluidic device 1. The second fluidic detection unit 33 allows specific analysis of washing and/or regeneration liquids.

A first outlet manifold 34 and a second outlet manifold 35 are fluidly connected to the fluidic device 1. The first outlet manifold 34 is used to collect the fluid 2 purified or partially purified by the fluidic device 1. The second manifold 35 allows to collect the regenerating fluid or the washing fluid downstream of the fluidic device 1. Fluids can be selectively conveyed to one or other of the manifolds for example by means of a valve controlled by a control unit 26.

A collection unit for regenerating fluids and/or washing fluids 37 is connected to the second outlet manifold 35.

A control unit 26 is electrically connected to the pump 30, pressure controller 31, selector valve 38, temperature conditioning devices 27, first and second outlet manifolds 34 and 35. The control unit can be a computer comprising a microprocessor and a memory. Data communication between the central unit and the other components of a purification system can be implemented via one or more wireless links. The different manifolds and/or valves can be adapted to redirect the different fluids upstream of the fluidic device 1 to allow recirculation of the fluid 2.

The detection units 32,33 may include sensors, microsystems or lab-on-a-chip to perform various fluid analyses downstream of the fluidic device 1, and transmit these analyses to the control unit. This data allows closed-loop control of recirculation in the purification system. Control units can also include fluid turbidity sensors and/or UV spectrometers. More generally, the system is adapted to purify the fluid 2 by implementing at least one recirculation of the fluid 2 in the microfluidic channel array.

The various arrows illustrate possible fluid flows in the system, the continuous lines illustrate fluid connections in the system, the dashed lines illustrate connections allowing heat transfer and the gray lines illustrate a network allowing pressure control at the ends of the network.

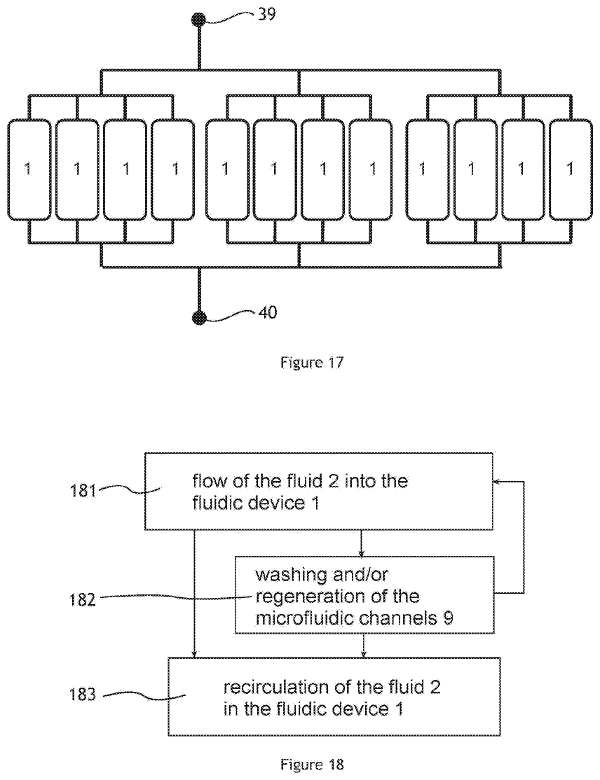

With reference to FIG. 17, a purification network may comprise several fluidic devices 1. The different fluidic devices 1 may be arranged in parallel, as shown in FIG. 17. For example, a purification assembly can treat a fluid 2 at a higher flow rate than a system with a single fluidic device 1 as described in FIG. 16. In another configuration, different fluidic devices 1 can be connected in series, Thus, a fluid 2 introduced into the system can be purified of a pollutant 3 more efficiently and without recirculation of the fluid 2 in the same fluidic device 1. A series of different fluidic devices 1 can also purify the fluid 2 of several pollutants 3. A first fluidic device 1 comprising a first self-contained purification agent 11 can for example be connected in series with a second fluidic device 1 comprising a second self-contained purification agent 11 to form a system suitable for treating two pollutants 3. A series of fluidic devices 1 can comprise between 2 and 20 fluidic devices 1, preferentially between 3 and 10 fluidic devices 1.

FIG. 17 schematically illustrates a system consisting of 12 fluidic devices 1 connected fluidically in parallel, A partially contaminated medium 2 can be introduced at the inlet of the system 39. An array of fluidic connections connects system inlet 39 to each of the inlets 4 of the fluidic devices 1, The purified fluid 2 can be collected at the outlet 5 of the fluidic devices 1. An array of fluidic connections connects each of the outlets 5 of the fluidic devices 1 to the outlet 39 of the purification system. The purification system can comprise between 1 and 200 fluidic devices 1, preferentially between 8 and 50 fluidic devices 1 and preferentially between 12 and 20 fluidic devices 1. Thus, a fluid 2 can be depolluted or purified of a pollutant 3 using a device with a small filling volume compared to known devices. For example, a standard 50 L rack 28 may consist of 30 fluidic devices 1, each fluidic device 1 comprising a stack 14 of 500 first layers 17 and second layers 18 alternately stacked, as described in FIG. 10. The total volume of the fluid 2 that can be included in such a purification system is approximately 2 L. Such a system makes it possible to purify a fluid 2 at a flow rate of 150 L/min, i.e. 200,000 L/day, by applying a pressure difference substantially equal to 0.1 bar between the inlet 39 and the outlet 40 of the system, in general, the flow rate of a purification system with multiplexed devices can reach 10,000 m³/day, or approximately 417,000 L/h. Such purification systems can be portable and electrically self-contained, and are therefore suitable for use in isolated environments. In addition, such systems can be adapted to purify industrial effluents for example at flows between 25 and 2500 L/min.

With reference to FIG. 18, the process for purifying a fluid 2 may consist of several steps.

In Step 181, a fluid 2 is passed through a microfluidic channel array 9 at a flow rate of the fluid to be purified. The speed of the fluid flow 2 or its rate of flow may be controlled by a pump 30 or a pressure controller 31, and selected to allow the self-contained purification agents 11 capture and/or degradation of at least 10%, preferentially at least 40% and preferentially at least 90% and preferentially 100% of the pollutants 3, at the flow rate of the flow. The proportion of the pollutants 3 can be measured by the first detection unit 32 downstream of the device 1. The formula (2) is used to calculate the Péclet number Pe corresponding to a pollutant 3 in the flow. The diffusion coefficient D and the length l′ are known values. The value of the flow rate can be calculated according to the geometry of the different channels of the system and according to the pressure applied to the system. Thus, in step 181 a fluid flow 2 is controlled in which Pe is less than 10⁴, preferentially less than 10 and preferentially less than 1. The flow velocity of the fluid 2 can also be chosen so that the Péclet number of the pollutant 3 in fluid 2 is between 10⁻² and 10⁴, preferentially between 10⁻¹ and 10 and preferentially between 1 and 10² and: thus the diffusion can allow the pollutants 3 of a fluid 2 to be partially or totally captured or degraded by one or more self-contained purification agents 11, while corresponding to a flow rate sufficient for industrial applications of the purification process. In order to purify a fluid 2 with the same pollutant 3 abatement rate, it is possible to circulate the fluid in the fluidic device 1 only once at a low Péclet number of the pollutant 3, for example less than 10 and preferentially less than 1, or to carry out recirculation of the fluid 2 at a higher flow rate and therefore at a higher Péclet number of the pollutant 3, for example less than 10000 and preferentially less than 1000, and more preferentially less than 1000.

In step 182, the microfluidic channels are washed or regenerated as described above. This step may be followed by step 181. Thus, it is possible to purify a large volume of the fluid 2 by interrupting the flow of the fluid 2 by washing or regeneration of the self-contained purification agents 11.

In step 183, the fluid 2 is recirculated. Step 183 can be performed in parallel with step 181. Recirculation can be implemented by recirculating the fluid 2 in the same direction as the first circulation of the fluid 2, or in the opposite direction. In addition, the circulation and/or recirculation of the fluid 2 may be pulsed, i.e. the flow rate is not constant and is periodic. Pulsed recirculation can optimize the interaction between a pollutant 3 and a self-contained purification agent 11.

### General Microfabrication Elements

The manufacture of the microfluidic channels 9, and more generally, of the channels of the fluidic distribution network 6, the fluidic connection network 7 and the fluidic purification network 8, can be implemented using microfabrication techniques using for example a substrate made of silicon, glass, but also thin, thick, rigid or flexible polymer material. A substrate can be molded, etched or micromachined. A mechanically robust substrate can present 2D and 3D microfluidic elements. The channels of the different fluidic networks can also be made by a low-cost lithographic microfabrication process using hot printing. For example, it is possible to thermomould a CD made of thermoplastic elastomeric material (similar to a plastic audio/video CD) so as to produce a plurality of interconnected microchannels, a plurality of interconnected fluid reservoirs and other dosing and mixing units.

### Examples of Purifications

The purification of previously polluted water by a purification system comprising a fluidic purification device 1 was implemented.

Flows 16 of water previously polluted by various pollutants 3 were controlled in a fluidic device 1 comprising a stack 14 of 23 sub-stacks comprising a first layer 17 and a second layer 18. A controlled pressure difference of 175 Pa between the inlet and outlet of the purification system results in a fluid flow rate 2 of 2.3 L/min. The first layers 17 of thermoplastic elastomer (Flexdym, registered trademark) have a thickness of 1.3 mm and recessed structures produced by printing lithography on one side 21, using a mold microstructured with epoxy type resin. The second purification layers 18 are 0.5 mm thick. The material of the second layers 18 is an EVOH/PCCD mixture, the mass concentration of PCCD being approximately 38%. The second layers 18 are manufactured beforehand by an extrusion process, The height of the microfluidic channels 9 is 10 μm.

Table 2 shows the development of the abatement rate of pollutant 3 with the flow rate of fluid 2 controlled in the purification system. Water polluted with lead at a mass concentration of 0.1 μg/L is initially introduced into the purification system. Purification is carried out at room temperature (20° C.), at a continuously controlled flow rate, without washing the system and without the release of the pollutants 3 by the self-contained purification agents 11.

TABLE 2

| Flow rate | 50 L/min | 20 L/min | 5 L/min | 1 L/min |
|---|---|---|---|---|
| Abatement rate | 30% | 62% | 85% | 93% |

Table 3 shows the development of the abatement rate of pollutant 3 with the flow rate of fluid 2 controlled in the purification system. Water polluted with carbamazepine at a mass concentration of 0.1 μg/L⁰ is initially introduced into the purification system. Purification is carried out at room temperature (20° C.), at a continuously controlled flow rate, without washing the system and without the release of the pollutants 3 by the self-contained purification agents 11.

TABLE 3

| Flow rate | 50 L/min | 20 L/min | 5 L/min | 1 L/min |
|---|---|---|---|---|
| Abatement rate | 14% | 31% | 56% | 87% |

1. A fluidic purification device (1) adapted to purify a fluid (2) of at least one pollutant (3), comprising a fluidic purification network (8), characterized in that the fluidic purification network is a three-dimensional array of microfluidic channels (9), each microfluidic channel (9) being defined by one or more fluid-tight walls (2), each microfluidic channel (9) comprising at least one zone (13) on the inner surface of said microfluidic channel (9) having at least one self-contained purification agent (11) and each microfluidic channel (9) having at such a zone (13) a height of less than 60 μm in a direction normal to the main direction of flow (12) of the fluid, the self-contained purification agent or agents and the dimensioning of said zones (13) being configured to allow capture and/or degradation of at least 10% of the pollutants (3) by said zones, for at least one flow of the fluid to be purified, the device comprising a plurality of distribution channels (40) and a plurality of collection channels (41), the fluidic purification network (8) connecting the distribution channels and the collection channels and being implemented at least by an array of microfluidic channels (9) connected in parallel.

2. A fluidic device (1) in which a three-dimensional array of microfluidic channels (9) comprising a superposition of two-dimensional arrays of microfluidic channels (9), the fluidic purification network (8) connecting the distribution channels (40) and the collection channels (41).

3. The device as claimed in claim 1, comprising at least three stacked layers (17, 18), at least two sides of one or more layers having, facing at least two Layers, a depression pattern configured to form at least two two-dimensional arrays of microfluidic channels (9) when the at least three layers are stacked.

4. The fluidic device (1) as claimed in one of claims 1 to 3, wherein the hydrodynamic resistance of the distribution channel(s) and the collection channel(s) is strictly lower than the hydrodynamic resistance of the fluidic purification network.

5. The device as claimed in claim 4, comprising at least three stacked layers (17, 18), at least two sides of one or more layers having, facing at least two layers, a depression pattern configured to form at least two two-dimensional arrays of microfluidic channels (9) when the at least three layers are stacked, wherein one said pattern is configured to form at least in part one or more distribution channels (40), and at Least in part one or more collection channels (41).

6. The device as claimed in one of claims 3 to 5, comprising at least one primary channel (19) passing through a plurality of adjacent layers (17, 18) and opening into at least one distribution channel (40) and/or at least one collection channel (41) formed between two layers (17, 18).

7. The device as claimed in one of claims a to 6, wherein the stack (14) comprises a superposition of sub-stacks each formed of two layers (17, 18), said two layers being of different materials.

8. The device as claimed in one of claims 3 to 6, wherein the stack (14) comprises a superposition of sub-stacks each formed of three consecutive layers (17, 18), the two layers on either side of the sub-stack being of the same material.

9. The device as claimed in one of claims 3 to 8 wherein the material of a second layer (18) has a mass fraction of self-contained purification agent (11) greater than 0.15.

10. The device as claimed in one of claims 3 to 9 wherein the material of a layer (17, 18) comprises a polycondensate of cyclodextrins.

11. The device as claimed in one of claims 3 to 10 wherein the material of a layer (17, 18) comprises an ethylene-vinyl alcohol copolymer.

12. The device as claimed in one of claims 3 to 11 wherein the material of at least two layers (17, 18) in contact, comprises a block copolymer, the block copolymer having a glass transition temperature below 0° C. and the material having a Young's modulus of less than 10 MPa.

13. The device as claimed in one of claims 3 to 12 wherein the material of a layer (17, 18) comprises a styrenic thermoplastic elastomer.

14. The device as claimed in one of claims 1 to 13, wherein the material of a layer is at least selected from glass and silicon.

15. The device as claimed in one of claims 1 to 14, wherein a self-contained purification agent (11) is adapted to capture the pollutant (3) and is at least one selected from cyclodextrin, activated carbon, calixarene, activated alumina, silica get, graphite, clay and zeolite.

16. The device as claimed in one of claims 1 to 15, wherein a self-contained purification agent (11) is adapted to degrade the pollutant (3) and is at Least one selected from laccase, horseradish peroxidase, lignin peroxidase, manganese peroxidase, tyrosinase, potassium permanganate, persulfate and a fungal enzyme.

17. The device as claimed in one of claims 1 to 16, wherein at least one wall of a microfluidic channel (9) has a plurality of reliefs (38) extending in at least one direction different from the main direction of flow (12) of the fluid.

18. The device as claimed in claim 17, wherein the reliefs are in the form of striations and/or chevrons.

19. A purification assembly adapted to purify a fluid (2) of at least one pollutant (3), comprising a plurality of fluidic devices (1), each fluidic device (1) comprising a fluidic purification network (8), said fluidic purification network being a three-dimensional array of microfluidic channels (9), each microfluidic channel (9) being defined by one or more fluid-tight walls (2), each microfluidic channel (9) comprising at least one zone (13) on the inner surface of said microfluidic channel (9) having at least one self-contained purification agent (11) and each microfluidic channel (9) having at such a zone (13) a height of less than 60 μm in a direction normal to the main direction of flow (12) of the fluid, the self-contained purification agent or agents and the dimensioning of said zones (13) being configured to allow (11) a capture and/or degradation of at least 10% of the pollutants (3) by said zones, for at least one flow of the fluid to be purified, the device comprising a plurality of distribution channels (40) and a plurality of collection channels (41), the fluidic purification network (8) connecting the distribution and collection channels and being implemented at least by an array of microfluidic channels (9) connected in parallel, the fluidic devices (1) being fluidically connected in series and/or in parallel.

20. A purification system comprising at least one fluidic purification device (1) adapted to purify a fluid (2) of at least one pollutant (3), each fluidic device (1) comprising a fluidic purification network (8), said fluidic purification network being a three-dimensional array of microfluidic channels (9), each microfluidic channel (9) being defined by one or more fluid-tight walls (2), each microfluidic channel (9) comprising at least one zone (13) on the inner surface of said microfluidic channel (9) having at least one self-contained purification agent (11) and each microfluidic channel (9) having at such a zone (13) a height of less than 60 μm in a direction normal to the main direction of flow (12) of the fluid, the self-contained purification agent or agents and the dimensioning of said zones (13) being configured to allow (11) a capture and/or degradation of at least 10% of the pollutants (3) by said zones, for at least one flow of the fluid to be purified, the device comprising a plurality of distribution channels (40) and a plurality of collection channels (41), the fluidic purification network (8) connecting the distribution channels and the collection channels and being implemented at least by a array of microfluidic channels (9) connected in parallel, the system also comprising a device for conditioning the temperature of a microfluidic channel (9).

21. The purification system as claimed in claim 20, which is portable and/or electrically self-contained.

22. The purification system as claimed in one of claim 20 or 21 comprising at least one ultrasonic radiation source (25).

23. A purification process adapted to purify a fluid (2) of at least one pollutant (3), comprising a step wherein the fluid (2) is passed through a three-dimensional fluidic purification network (8) of microfluidic channels (9) at a flow rate of the fluid to be purified, each microfluidic channel (9) comprising at least one zone (13) on the inner surface of said microfluidic channel (9) having at least one self-contained purification agent (11) and each microfluidic channel (9) having at such a zone (13) a height of Less than 60 μm in a direction normal to the main direction of flow (12) of the fluid, the self-contained purification agent or agents and the dimensioning of said zones (13) being configured to allow (11) a capture and/or degradation of at least 10% of the pollutants (3) by said zones during the flow of the fluid (2) at said flow rate in the array of microfluidic channels (9), comprising controlling a pressure difference between the inlet (4) and the outlet (5) of a device (1) so as to cause said fluid flow (2) into said device (1), the device (2) comprising a plurality of distribution channels (40) connected to the inlet (4) and a plurality of collection channels (41) connected to the outlet (5), the fluidic purification network (8) connecting the distribution channels and the collection channels, the hydrodynamic resistance of the distribution channel or channels and the collection channel or channels being strictly lower than the hydrodynamic resistance of the fluidic purification network and the absolute value of the pressure difference being less than 5 bar.

24. The process as claimed in claim 23, wherein the flow rate is such that the Peclet number of the pollutant (3) in the flow of the fluid (2) passing through the length of the purification zones (13) in the direction of flow is less than 10⁴.

25. The process as claimed in one of claims 23 to 24 wherein the fluid (2) is recirculated in the microfluidic channels (9).

26. The process as claimed in one of claims 23 to 25, wherein, for the purification of a pollutant (3) selected from a metallic element and an organic molecule having an octanol/water partition coefficient LogK_{ow}, greater than 1.5, the self-contained purification agent (11) is a cyclodextrin.

27. The process as claimed in one of claims 23 to 26, comprising a step in which a washing and/or regeneration fluid is passed through the microfluidic channels (9).

28. A process for manufacturing a fluidic purification device (1) adapted to purify a fluid (2) of at least one pollutant (3), comprising a fluidic purification network (8), the fluidic purification network being a three-dimensional array of microfluidic channels (9), each microfluidic channel (9) being defined by one or more walls fluid-tight to the fluid (2), each microfluidic channel (9) comprising at least one zone (13) on the inner surface of said microfluidic channel (9) having at least one self-contained purification agent (11) and each rnicrofluidic channel (9) haying at such a zone (13) a height of less than 60 μm in a direction normal to the main direction of flow (12) of the fluid, the self-contained purification agent(s) and the dimensioning of said zones (13) being configured to allow (11) a capture and/or degradation of at least 10% of the pollutants (3) by said zones, for at least one flow of the fluid to be purified, the fluidic device 1 also comprising at least three stacked layers (17, 18), at least two sides of one or more layers having, facing at least two layers, a depression pattern configured to form at least one two-dimensional array of microfluidic channels (9) when the two layers are stacked, the material of each of the layers (17, 18) having a glass transition temperature below 0° C., the bonding between two layers being achieved solely by bringing the two layers into contact at a temperature between 0° C. and 50° C.
